(19) United States
(12) Patent Application Publication
(10) Pub. No.: US 2003/0115476 A1
(43) Pub. Date: Jun. 19, 2003

(54) Hardware-enforced control of access to memory within a computer using hardware-enforced semaphores and other similar, hardware-enforced serialization and sequencing mechanisms

(76) Inventor: Bret McKee, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/999,753

(22) Filed: Oct. 31, 2001

(51) Int. Cl. G06F 12/14

(52) U.S. Cl. 713/193

(57) ABSTRACT

Method and system for providing hardware-enforced synchronization and serialization mechanisms, such as semaphores, to allow for control of access to memory regions within a computer system. In addition to the traditional semaphore protocol, hardware enforced semaphores are associated with memory regions and with protection keys selected from a pool of protection keys that control access to those memory regions. Hardware-enforced semaphores control insertion and deletion of protection keys from protection-key registers and internal data structures in order to enforce access grants provided by the semaphore protocol.

### TECHNICAL FIELD

The present invention relates to computer architecture and control of access to memory within computer systems by executing processes and threads and, in particular, to a method and system for providing semaphores and similar access control mechanisms to executing processes and threads that employ hardware-based memory-protection facilities to enforce semaphore-based memory access control..

### BACKGROUND OF THE INVENTION

The present invention is related to semaphores and related computational techniques that provide mechanisms for processes and threads running within a computer system to serialize, or partially serialize, access by the processes and threads to regions of memory. A semaphore generally allows a fixed, maximum number of processes or threads to concurrently access particular regions of memory protected by the semaphore. The semaphore provides a wait, or lock, function, and a signal, or release, function to processes and threads that use the semaphore. A process calls the lock function prior to attempting to access the memory region protected by a semaphore. If less than the maximum number of processes or threads are currently granted access to the memory region by the semaphore, then the process or thread is immediately granted access, and an internal data member within the semaphore reflecting the number of processes or threads that may still be granted access is decremented. If the maximum number of processes or threads are currently granted access to the memory region by the semaphore, then the process or thread calling the lock function is suspended on a wait queue until a sufficient number of the processes and threads currently granted access to the protected memory region release their access grants by calling the unlock function of the semaphore. Access to the semaphore itself is guarded by a mutex lock, spin lock, or other such device for guaranteeing that only one process or thread may access semaphore routines at any particular instant in time. There are various other synchronization and serialization primitives related to semaphores, generally involving queuing mechanisms and critical-section locks, and the techniques of the present invention may be applied equally as well to these other synchronization and serialization primitives as to semaphores.

Semaphores have been known and used for many years, and have provided a necessary and useful tool for controlling concurrent and parallel access to memory and other computer resources by concurrently and simultaneously executing processes and threads. If properly used, semaphores enable memory access and access to other resources to be tightly and correctly controlled. However, semaphore use is similar to use of a protocol or convention. While processes should always obtain a grant to access a memory region, protected by a semaphore, from the semaphore controlling access to the memory region, they are not compelled or obligated to do so. Due to a programming error, for example, a process may access the memory region without first having obtained a grant from the controlling semaphore. Failure to conform to the protocol or convention requiring access through the semaphore can lead to serious problems in execution of the processes and threads far downstream from the initial failure to access the memory region through the semaphore, including subtle data corruption, process starvation, system crashes, and other such problems. Many such programming errors are notoriously difficult to diagnose. Millions or billions of instructions may be executed in the time between the failure to access a resource through a semaphore and the manifestation of that failure in a fault, trap, crash, detectable data corruption, or other problem. Designers and manufacturers of computer systems, operating-system developers, software application developers, and computer users have recognized the need for a more robust, semaphore-like technique for protecting access by executing processes and threads to memory and other computer resources that can detect programming errors involving failure to follow the semaphore protocol for obtaining and releasing access rights.

### SUMMARY OF THE INVENTION

One embodiment of the present invention is a semaphore mechanism provided by kernel or kernel and operating-system layers of a modern computer to facilitate serialization and synchronization of access to memory by processes and threads executing within the computer system. Processes and threads access memory protected by a traditional semaphore via a well-known protocol in order to obtain and to later relinquish access to a memory region or other computer resource protected by the semaphore. Semaphores generally allow a fixed number of one or more processes or threads to concurrently access a protected resource. A hardware-enforced semaphore is associated with a memory region that it protects. Both the protected memory region and the semaphore are further associated with a protection key selected from a pool of protection keys allocated for hardware-enforced semaphores and other serialization-and-sequencing devices. A protection key is a value that can be inserted into a protection-key register to allow access to a memory region associated with the protection-key register, according to a memory-access-control-mechanism provided by certain modern computer systems. When the hardware-enforced semaphore grants access to the protected memory region to a process or thread, the semaphore inserts the protection key associated with the semaphore and protected memory region into the protection-key registers and, in addition, associates the protection key with internal data structures associated with the process or thread. If the process or thread relinquishes access to memory via the semaphore protocol, a hardware-enforced semaphore removes the protection key associated with the semaphore from the protection-key registers as well as from the data structure associated with the process or thread.

### BRIEF DESCRIPTION OF THE DRAWINGS

FIG. 1 is a block diagram showing hardware, operating-system and application-program layers within a generalized computer system.

FIG. 2 shows logical layers within a modern, 4-privilege-level computer system.

FIG. 3 illustrates partitioning of memory resources between privilege levels in certain 4-privilege-level computer systems.

FIG. 4 illustrates translation of a virtual memory address into a physical memory address via information stored within region registers, protection-key registers, and a translation look-aside buffer.

FIG. 5 shows the data structures employed by an operating system routine to find a memory page in physical memory corresponding to a virtual memory address.

FIG. 6 shows the access rights encoding used in a TLB entry.

FIG. 7 illustrates privilege-level transitions during execution of a process.

FIG. 8 summarizes, in graphical fashion, the features of the hardware-enforced semaphore described above that represents one embodiment of the present invention.

### DETAILED DESCRIPTION OF THE INVENTION

Semaphores and other, similar serialization and sequencing methodologies are normally encoded in software routines and are effective in sequencing and serializing access to memory and other computer services only to the extent that processes and threads comply with a semaphore-based protocol for memory access. In other words, a process or thread may access the protected memory without first obtaining an access grant via the semaphore by ignoring the protocol. The unauthorized access may not be detected, or may only be indirectly detected through various error conditions that arise later, including data corruption, faults and traps, process aborts, and even system crashes. One embodiment of the present invention provides a method and system for controlling access to memory within a computer system using hardware-enforced semaphores and other, similar hardware-enforced synchronization and sequencing methodologies.

The embodiment of the present invention described below employs various hardware-based memory-protection facilities of modem computer architectures in order to provide hardware-enforced semaphores that generate machine-level faults in the case that processes and threads fail to conform to the semaphore-based protocol for memory access. Thus, the technique of the present invention ensures that a process or thread may not access a memory region protected by a hardware-enforced semaphore unless the process or thread has first obtained access to the memory region via a call to a semaphore routine.

The following description is divided into two subsections: (1) a review of modern computer hardware and operating system architecture; and (2) a detailed description of one embodiment of the present invention that refers to a C++-like pseudocode implementation. The first part of the first subsection is quite general in nature, but the second part of the first subsection details the virtual address translation and protection-key memory-access architecture and primitives of the Intel® IA-64 computer architecture.

Computer Hardware and Operating System Structure

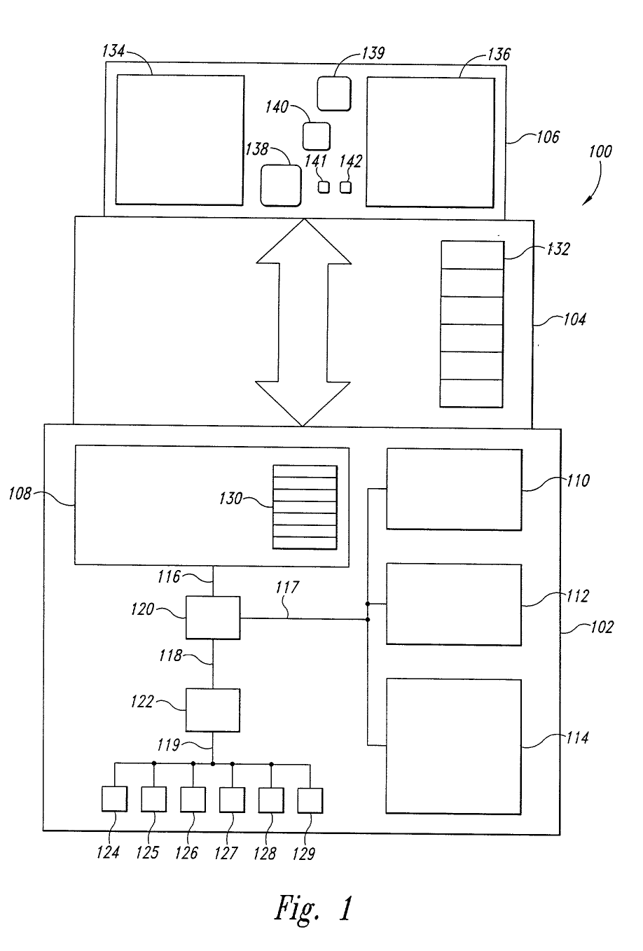

FIG. 1 is a block diagram showing hardware, operating-system, and application-program layers within a generalized computer system. A computer system 100 can be considered to comprise a hardware layer 102, an operating-system layer 104, and an application-programming layer 106. Computer systems are quite complex, with many additional components, sub-layers, and logical entity interrelationships, but the 3-layer hierarchy shown in FIG. 1 represents a logical view of computer systems commonly employed within the computer software and hardware industries.

The hardware layer 102 comprises the physical components of a computer system. These physical components include, for many small computer systems, a processor 108, memory storage components 110, 112, and 114, internal buses and signal lines 116-119, bus interconnect devices 120 and 122, and various microprocessor-based peripheral interface cards 124-129. The processor 108 is an instruction-execution device that executes a stream of instructions obtained by the processor from internal memory components 110, 112, and 114. The processor contains a small number of memory storage components referred to as registers 130 that can be quickly accessed. Data and instructions are read from, and written to, the memory components 110, 112, and 114 via internal buses 116 and 117 and the bus interconnect device 120. Far greater data storage capacity resides in peripheral data storage devices such as disk drives, CD-ROM drives, DVD drives, and other such components that are accessed by the processor via internal buses 116, 118, and 119, interconnect devices 120 and 122, and one or more of the peripheral device interconnect cards 124-129. For example, the stored instructions of a large program may reside on a disk drive for retrieval and storage in internal memory components 110, 112, and 114 on an as-needed basis during execution of the program. More sophisticated computers may include multiple processors with correspondingly more complex internal bus interconnections and additional components.

The operating-system layer 104 is a logical layer comprising various software routines that execute on the processor 108 or one or more of a set of processors and that manage the physical components of the computer system. Certain operating system routines, in a traditional computer system, run at higher priority then user-level application programs, coordinating concurrent execution of many application programs and providing each application program with a run-time environment that includes processor time, a region of memory addressed by an address space provided to the application program, and a variety of data input and output services, including access to memory components, peripheral devices, communications media, and other internal and external devices. Currently running programs are executed in the context of a process, a logical entity defined by various state variables and data structures managed by the operating system. One important internal data structure managed by the operating system is a process queue 132 that contains, for each currently active process, a process-control block or similar data structure that stores data that defines the state of the currently active process managed by the operating system.

The application-programming and user interface layer 106 is the user-visible layer of the computer system. One embodiment of the current invention relates primarily to the application program interface as well as to internal kernel and operating-system interfaces, and thus the application-programming and user interface layer will be discussed primarily with reference to the application program interface. An application program comprises a long set of stored instructions 134, a memory region addressed within an address space provided by the operating system to the process executing the application program 136, and a variety of services 138-142 provided through the operating-system interface that allow the application program to store data to, and retrieve data from, external devices, access system information, such as an internal clock and system configuration information, and to access additional services.

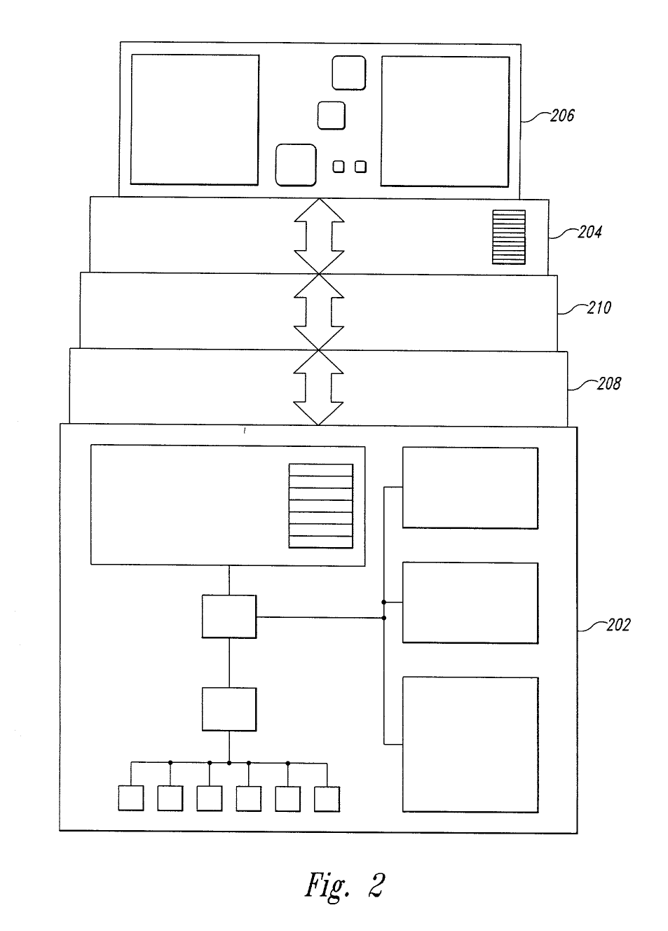

FIG. 2 shows logical layers that may inter-cooperate within a modem, 4-privilege-level computer system. In FIG. 2, the hardware level 202, operating system level 204, and application-programming level 206, are equivalent to the corresponding hardware, operating-system, and application program levels 102, 104, and 106 in the traditional computing system shown in FIG. 1. The 4-privilege-level computer system may also include two additional levels 208 and 210 between the hardware level 202 and the operating system level 204. The first logical level at these additional levels 208 represents certain fundamental, highly-privileged kernel routines that operate at privilege level 0. The second logical layer 210 represents a control-program level that includes various relatively highly privileged service routines that run at privilege level 1. The operating system level 204 includes operating system routines that run at privilege level 2. Application programs, in the 4-privilege-level computer system, run at privilege 3, the least privileged level. The highly-privileged kernel routines that together compose logical layer 208 may be designed to be verifiably correct and provide critical services, including encryption services, that require fully secure management.

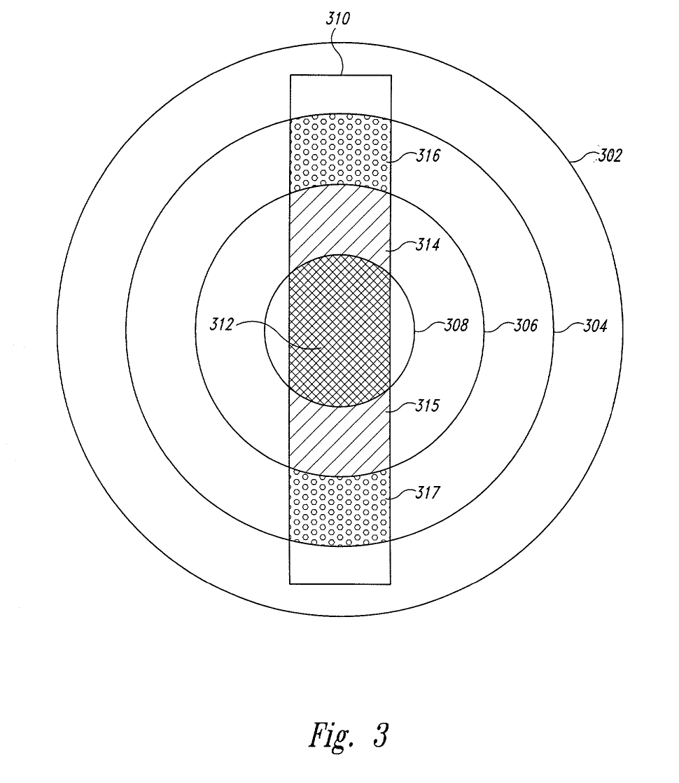

FIG. 3 illustrates partitioning of memory resources between privilege levels in a four-privilege-level computer system. A privilege level is a value contained within a process-status control register of a processor within the hardware layer of the computer system. Certain modern computer systems employ four privilege levels: 0, a most privileged level, or kernel-privilege level; 1, a second-most privileged level, used by certain global services routine; 2, an operating-system privilege level, at which complex operating system routines execute; and 3, a least-privileged level, or application-program privilege level. The current privilege level (“CPL”) for a currently executing process can be represented by a two or more CPL bits within the process status register. For example, when the two CPL bits express, in the binary number system, the value “0,” the currently executing process executes at kernel-privilege level, and when the CPL bits express the value of “3,” the currently executing process executes at application-privilege level. The privilege level at which a process executes determines the total range or ranges of virtual memory that the process can access and the range of instructions within the total instruction set that can be executed by the processor on behalf of the process. Memory resources accessible to routines running at privilege level 0 are represented by the area within the outer circle 302 in FIG. 3. Memory resources accessible to routines running at privilege levels 1, 2, and 3 are represented by the areas within circles 304, 306, and 308, respectively. The total accessible memory is represented by rectangle 310. As shown in FIG. 3, a process running at privilege level 3 can only access a subset 312 of the total memory space. However, an operating-system routine operating at privilege level 2 can access memory accessible by an application program running at privilege 3 as well as additional memory 314-315 accessible to routines running at privilege levels 2-0. In similar fashion, a routine running at privilege level 1 can access memory accessible to routines running at privilege levels 3 and 2, as well as additional memory 316-317 accessible only to processes running at privilege levels 1 and 0. Finally, a routine running at privilege level 0 can access the entire memory space within the computer system.

The privilege concept is used to prevent full access to computing resources by application programs and operating systems. In order to obtain services that employ resources not directly available to application programs, application programs need to call operating system routines through the operating system interface. Operating system routines can promote the CPL to privilege level 2 in order to access the necessary resources, carry out a task requested by an application program, and then return control to the application program while simultaneously demoting the CPL back to privilege level 3. In similar fashion, the operating system may call kernel routines that execute at privilege level 0 in order to access resources protected from access by both application programs and operating systems. By restricting application-program access to computer resources, an operating system can maintain operating-system-only-accessible data structures for managing many different, concurrently executing programs, in the case of a single-processor computer, and, on a multi-processor computing system, many different concurrently executing application programs, a number of which execute in parallel. By restricting operating-system access to certain highly privileged data structures and resources, the computer system can fully secure those resources and data structures through access via verified and secure kernel routines. Privilege levels also prevent the processor from executing certain privileged instructions on behalf of application programs. For example, instructions that alter the contents of the process status register may be privileged, and may be executed by the processor only on behalf of a kernel routine running at privilege level 0. Generally, restricted instructions include instructions that manipulate the contents of control registers and special kernel-specific data structures.

As an example of the use of privilege levels, consider concurrent execution of multiple processes, representing multiple application programs managed by the operating system in a single-processor computer system. The processor can execute instructions on behalf of only a single process at a time. The operating system may continuously schedule concurrently executing processes for brief periods of execution in order to provide, over time, a fraction of the total processing bandwidth of the computer system to each running application program. The operating system schedules a process for execution by calling kernel routines to remove the process-control block corresponding to the process from the process queue and writing the contents of various memory locations within the process-control block into various control registers and operating-system data structures. Similarly, the operating system removes a process from the executing state by calling kernel routines to store the contents of control registers and operating-system data structures into the corresponding process-control block and to re-queue the process-control block to the process queue. Operating system routines are invoked through system calls, faults, traps, and interrupts during the course of execution of an application program. By maintaining the process queue in memory accessible only to routines executing at privilege level 0, and by ensuring that some or all instructions required to store and retrieve data from control registers are privilege level 0 instructions, the architecture of the computing system ensures that only operating-system routines can schedule application processes for execution. Thus, an application program may not manipulate the process queue and control registers in order to monopolize system resources and prevent other application programs from obtaining computing resources for concurrent execution.

A computer system, as part of providing an application programming environment, provides both application-specific and application-sharable memory to application programs. An application program may store private data that the application wishes to be inaccessible to other application programs in private memory regions, and may exchange data with other application programs by storing date in sharable memory. Access to memory is controlled by the computer system through address mapping and access privileges associated with memory pages, each memory page generally comprising some fixed number of 8-bit bytes. Because the instructions and data structures necessary for memory mapping and access privilege assignment include instructions and memory accessible only to routines executing at privilege level 0, an application program executing at privilege level 1 may not remap memory or reassign access privileges in order to gain access to the private memory of other application programs. Kernel routines that control memory mapping and access-privilege assignment protect one application program's private memory from that of other application programs.

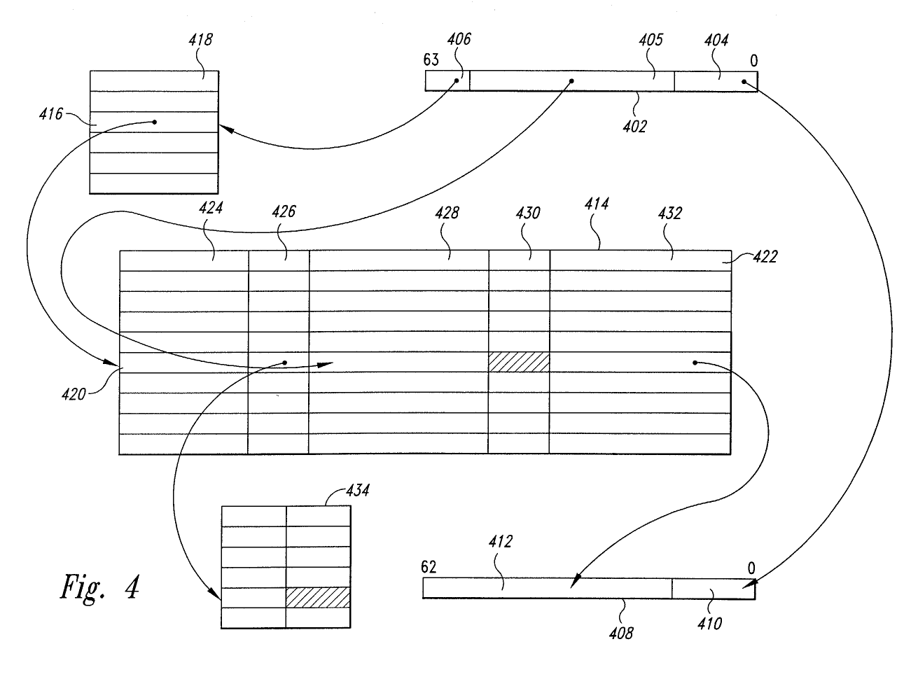

FIG. 4 illustrates translation of a virtual memory address into a physical memory address via information stored within region registers, protection-key registers, and a translation look-aside buffer (“TLB”). In certain modern computer architectures, such as the Intel® IA-64 architecture, virtual addresses are 64-bit computer words, represented in FIG. 4 by a 64-bit quantity 402 divided into three fields 404-406. The first two fields 404 and 405 have sizes that depend on the size of a memory page, which can be adjusted within a range of memory page sizes. The first field 404 is referred to as the “offset.” The offset is an integer designating a byte within a memory page. If, for example, a memory page contains 4096 bytes, then the offset needs to contain 12 bits to represent the values 0-4095 in the binary number system. The second field 405 contains a virtual page address. The virtual page address designates a memory page within a virtual address space that is mapped to physical memory, and further backed up by memory pages stored on mass storage devices, such as disks. The third field 406 is a three-bit field that designates a region register containing the identifier of a region of memory in which the virtual memory page specified by the virtual page address 405 is contained.

Translation of the virtual memory address 402 to a physical memory address 408 that includes the same offset 410 as the offset 404 in the virtual memory address, as well as a physical page number 412 that references a page in the physical memory components of the computer system, is carried out by the processor, at times in combination with kernel and operating system routines. If a translation from a virtual memory address to a physical memory address is contained within the TLB 414, then the virtual-memory-address-to-physical-memory-address translation can be entirely carried out by the processor without operating system intervention. The processor employs the region register selector field 406 to select a register 416 within a set of region registers 418. The selected region register 416 contains a region identifier. The processor uses the region identifier contained in the selected region register and the virtual page address 405 together in a hash function to select a TLB entry 420. Alternatively, the TLB can be searched for an entry containing a region identifier and virtual memory address that match the region identifier contained in the selected region register 416 and the virtual page address 405. Each TLB entry, such as TLB entry 422, contains fields that include a region identifier 424, a protection key associated with the memory page described by the TLB entry 426, a virtual page address 428, privilege and access mode fields that together compose an access rights field 430, and a physical memory page address 432.

If an entry in the TLB can be found that contains the region identifier contained within the region register specified by the region register selector field of the virtual memory address, and that contains the virtual page address specified within the virtual memory address, then the processor determines whether the virtual memory page described by the virtual memory address can be accessed by the currently executing process. The currently executing process may access the memory page if the access rights within the TLB entry allow the memory page to be accessed by the currently executing process and if the protection key within the TLB entry can be found within the protection-key registers 434 in association with an access mode that allows the currently executing process access to the memory page. The access rights contained within a TLB entry include a 3-bit access mode field that indicates one, of a combination of, read, right, and execute privileges, and a 2-bit privilege level field that specifies the privilege level required of an accessing process. Each protection-key register contains a protection key associated with an access mode field specifying allowed access modes and a valid bit indicating whether or not the protection-key register is currently valid. Thus, in order to access a memory page described by a TLB entry, the accessing process must access the page in a manner compatible with the access mode associated with a valid protection key within the protection-key registers and associated with the memory page in the TLB entry and must be executing at a privilege level compatible with the privilege level associated with the memory page within the TLB entry.

If an entry is not found within the TLB with a region identifier and a virtual page address equal to the virtual page address within the virtual memory address and a region identifier selected by the region register selection field of a virtual memory address, then a TLB fault occurs and a kernel or operating system routine is invoked in order to find the specified memory page within physical memory or, if necessary, load the specified memory page from an external device into physical memory, and then insert the proper translation as an entry into the TLB. If, upon attempting to translate a central memory address to a physical memory address, the process does not find a valid protection key within the protection-key registers 434, or if the attempted access by the currently executing process is not compatible with the access mode in the TLB entry or associated with the protection key in the protection-key register, or the privilege level at which the currently executing process executes is less than the privilege level associated with the TLB entry or protection key, then a fault occurs that is handled by a kernel routine that dispatches execution to an operating system routine.

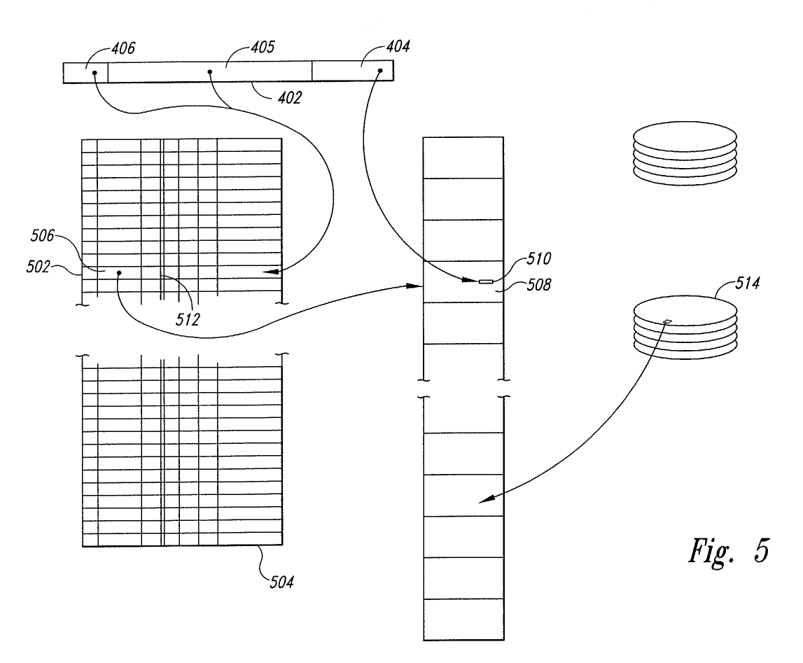

FIG. 5 shows the data structures employed by an operating system routine to find a memory page in physical memory corresponding to a virtual memory address. The virtual memory address 402 is shown in FIG. 5 with the same fields and numerical labels as in FIG. 4. The operating system routine employs the region selector field 406 and the virtual page address 405 to select an entry 502 within a virtual page table 504 via a hash function. The virtual page table entry 502 includes a physical page address 506 that references a page 508 in physical memory. The offset 404 of the virtual memory address is used to select the appropriate byte 510 in the virtual memory page 508. In some architectures, memory is byte addressable, while in others the finest addressable granularity may be a 32-bit or a 64-bit word. The virtual page table 502 includes a bit field 512 indicating whether or not the physical address is valid. If the physical address is not valid, then the operating system selects a memory page within physical memory to contain the memory page, and retrieves the contents of the memory page from an external storage device, such as a disk drive 514. The virtual page table entry 502 contains additional fields from which the information required for a TLB entry can be retrieved. If the operating system successfully translates the virtual memory address into a physical memory address, that translation, both as a virtual page table entry and as a TLB entry, is inserted into the TLB.

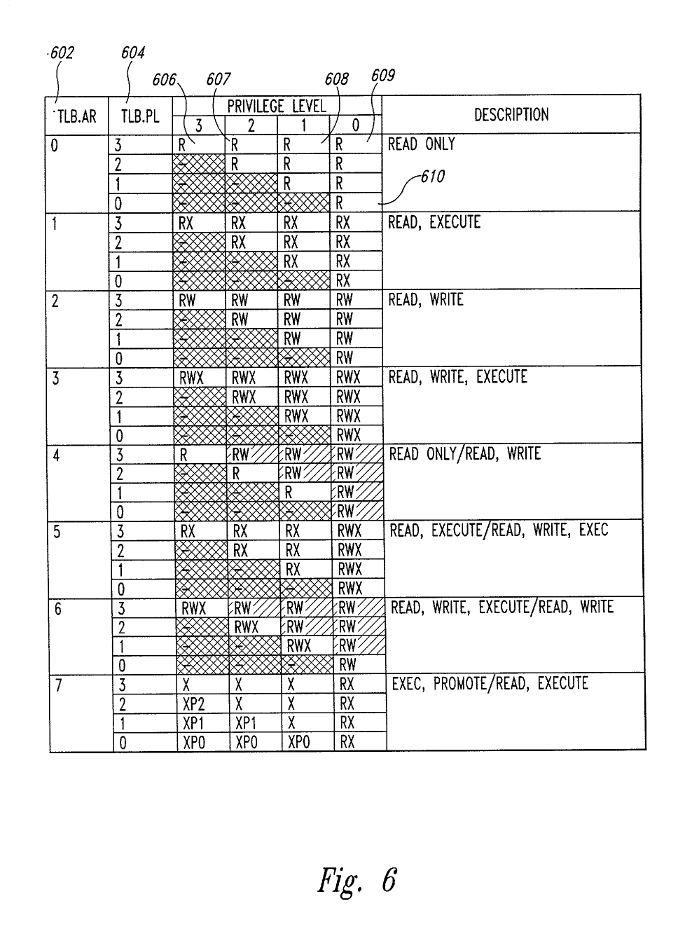

FIG. 6 shows the access rights encoding used in a TLB entry. Access rights comprise a 3-bit TLB.ar mode field 602 that specifies read, write, execute, and combination access rights, and a 2-bit TLB.pl privilege level field 604 that specifies the privilege level associated with a memory page. In FIG. 6, the access rights for each possible value contained within the TLB.ar and TLB.pl fields are shown. Note that the access rights depend on the privilege level at which a current process executes. Thus, for example, a memory page specified with a TLB entry with TLB.ar equal to 0 and TLB.pl equal to 3 can be accessed for reading by routines running at any privilege level, shown in FIG. 6 by the letter “R” in the column corresponding to each privilege level 606-609, while a memory page described by a TLB entry with TLB.ar equal to 0 and TLB.pl equal to 0 can be accessed by reading only by a process running at privilege level 0, as indicated in FIG. 6 by the letter “R” 610 under the column corresponding to privilege level 0. The access rights described in FIG. 6 nest by privilege level according to the previous discussion with reference to FIG. 4. In general, a process running at a particular privilege level may access a memory page associated with that privilege level and all lower privilege levels. Using only the access rights contained in a TLB entry, it is not possible to create a memory region accessible to a process running at level 3 and kernel routines running at level 0, but not accessible to an operating system routine running at privilege level 2. Any memory page accessible to a routine running at privilege level 3 is also accessible to an operating system routine executing at privilege level 2.

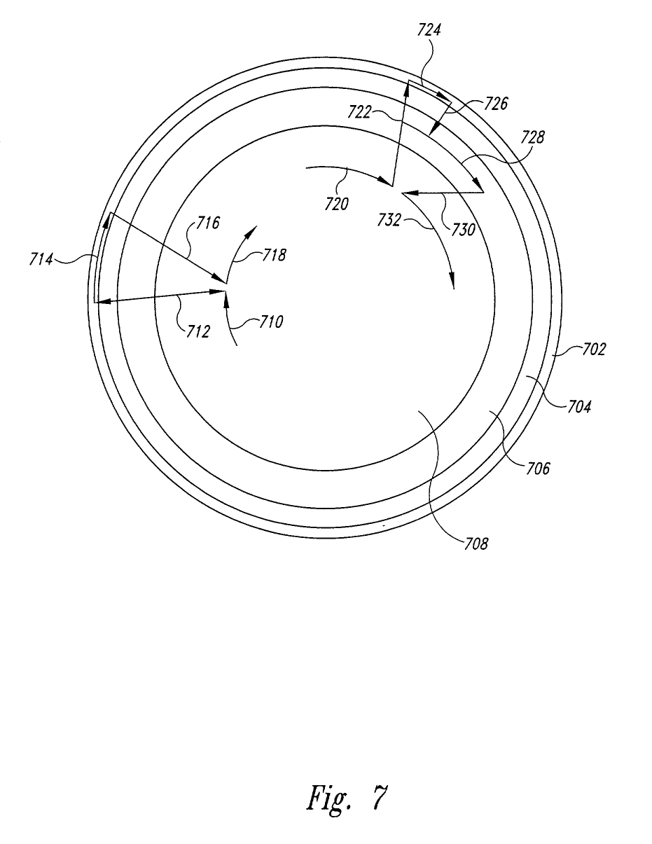

FIG. 7 illustrates privilege-level transitions during execution of a process. In FIG. 7, the outer circular ring 702 corresponds to privilege level 0, the highest privilege level, and rings 704, 706, and 708 correspond to privilege levels 1, 2, and 3, respectively. FIG. 7 illustrates a brief snapshot, in time, during execution of two processes. A first process executes an application routine at privilege level 3 (710 in FIG. 7). The application routine makes a system call which promotes 712 the privilege level to privilege level 0, at which privilege level a kernel routine executes 714 in order to carry out the system call. When the kernel routine completes, the privilege level is demoted 716 back to privilege level 3, at which privilege level the application program continues executing 718 following return from the system call. For example, the application routine may make a system call to a kernel routine that generates an encryption key and stores the encryption key in private memory. A second application program also executes 720 at privilege level 3. During its execution, either the application program makes a call to an operating-system routine, or an external interrupt occurs, in either case promoting 722 the privilege level to privilege level 0. A dispatch routine executes for a short time 724 at privilege level 0 in order to dispatch execution to an operating system routine. The dispatch is accompanied by a privilege level demotion 726 to privilege level 2, at which privilege level the operating system routine executes 728 in order to carry out the operating-system call or service the interrupt. When the operating system routine completes, the privilege level is demoted 730 back to privilege level 3, at which privilege level the application program continues execution 732. Thus, in the multi-privilege-level computer system, the current privilege level (“CPL”) can be promoted only via promotion to privilege level 0, either during a call to a system routine or as a result of an interrupt, fault, or trap.

### Hardware-Enforced Semaphore-Based Memory Access

In one embodiment of the present invention, the protection-key mechanism, discussed above, is used in conjunction with standard semaphore techniques in order to provide hardware-enforced semaphores to processes and threads that allow the processes and threads to serialize or partially serialize their accesses to memory. The protection-key mechanism, as discussed above, provides a hardware-level memory access control in addition to standard READ, WRITE, and EXECUTE access right associated with privileged levels, as described with reference to FIG. 6. One of a pool of protection keys can be assigned, by a privilege-level-0 kernel routine, to each memory region protected by a semaphore. Semaphore routines call kernel routines to insert the protection key into a protection-key register for a process or thread that obtains access to the memory by calling semaphore routines, as well as into an internal data structure associated with the process or thread, and to remove the protection key from the protection-key register via a kernel-routine call, as well as from the internal data structures, when the process or thread calls a semaphore routine to relinquish access to the memory region. A pool of protection keys is employed, in order to conserve protection keys for other uses. Although 2²⁴ protection keys are available in the Intel® IA-64 architecture, for example, it is conceivable that a large number of semaphores may be allocated during system operation, leaving less than an adequate number of unique protection-key values for assigning to memory regions not protected by semaphores. If a process attempts to access the memory region without obtaining an access thread from the semaphore, the process incurs a protection-key fault, which can be handled by a kernel-level protection-key fault handler, or by the kernel-level protection-key fault handler in combination with one or more operating-system routines.

In certain computers, the kernel routines run as part of the operating system, at the same priority as the operating system. In other computers, including the modern architecture described in the previous subsection, the kernel routines are separate from the operating system and run at a higher privilege level. In either case, as long as a protection-key mechanism or other hardware memory protection mechanism separate from an access-rights-based memory-protection mechanism is available at the hardware level, the methods of the present invention can be applied to provide hardware-enforced semaphores and similar access-control devices.

There are an almost limitless number of ways of implementing hardware-enforced semaphore based on the overall concept outlined in the previous paragraph. Moreover, there are many different variations possible for hardware-enforced semaphores. One particular implementation of one variation of a hardware-enforced semaphore is provided below, in a C++-pseudocode implementation. The C++-pseudocode outlines only those member functions and data members needed to describe the present invention, and relies on general kernel an/or operating system facilities, the implementations for which are well known in the art and therefore not provided in the C++-like pseudocode.

First, the C++-like pseudocode implementation includes a macro definition, a number of typedefs, a constant integer declaration, an enumeration, and number of forward class declarations:

| | |
|---|---|
| 1 | #define_SEM_LOG_EVENTS |
| 2 | typedef_int64 int64; |
| 3 | typedef_int32 int32; |
| 4 | typedef unsigned char byte; |
| 5 | typedef int32 Protection_Key; |
| 6 | typedef int64* Memory_Address; |
| 7 | typedef byte Privilege_Level; |
| 8 | typedef byte Access_Mode; |
| 9 | typedef struct access_rights |
| 10 | { |
| 11 | byte privilege_level; |
| 12 | byte access_mode; |
| 13 | }Access_Rights; |
| 14 | const int SEMKEY = 7; |
| 15 | enum EVENTS {SemaphoreCreation, SemaphoreDestruction, |
| | PKFault, etc}; |
| 16 | const int POOL_SIZE = 100; |
| 17 | class processControlBlock; |
| 18 | class kernel; |
| 19 | class semaphore; |
| 20 | class PKs; |

When the macro variable “_SEM_LOG_EVENTS” is defined, on line 1, various semaphore-related events are logged by the system in a log file to enable programmers and system designers to trace semaphore-related activities that lead to protection-key faults and other pathologies. The type definitions “int64,” “int32,” and “byte,” provided above on lines 2-4 define 64-bit, 32-bit, and 8-bit integer types, respectively. Next, on lines 5-13, four hardware-related types are provided: (1) Protection_Key, an integer-like type corresponding to the value of a protection key; (2) Memory_Address, a 64-bit virtual memory address; (3) Privilege_Level, a type that may contain one of the four privilege-level values “0,” “1,” “2,” and “3;” (4) Access_Mode, a small-integer type that contains one of the seven possible access modes in the translation look-aside buffer field “TLB.ar,” as shown in FIG. 6; and (5) Access_Rights, a two-field access rights type that includes a privilege level and an access mode, corresponding to the combined translation look-aside buffer fields “TLB.ar” and “TLB.pl.”

The constant “SEMKEY,” declared on line 14, identifies a particular protection-key register into which a semaphore-related protection key is inserted during acquisition, by a processor or thread, of a grant to access a memory region via a semaphore routine. In the current implementation, the protection key associated with the memory protected by a semaphore is always inserted into one particular protection-key register as well as into a table included within, or referenced from, a process control block for the process or thread. In a more elaborate implementation, a more complex algorithm may be employed to select an appropriate protection-key register in which to insert a semaphore-based protection key. Note, however, that the protection-key registers serve as a cache of protection keys associated with a given process or thread, much like the translation look-aside buffer serves as a cache of certain, recently accessed virtual-memory addresses. If a process calls routines to access two different semaphores close in time, access to the memory region protected by one of the two semaphores may result in a protection-key fault. However, a kernel-level protection-key-fault handler need only access the table of semaphore-related protection keys associated with the process or thread that incurs the fault in order to find and insert the proper protection key into the one of the protection-key registers, handling the protection-key fault in a manner fully transparent to the process or thread. However, if a more complex protection-key register-selection algorithm is employed, multiple semaphores can be acquired by a process or thread without necessarily incurring protection-key faults.

The enumeration “EVENTS,” declared on line 15, contains a number of semaphore-related events that can be logged to log files when the macro variable “_SEM_LOG_EVENTS” is defined, as it is in the current implementation on line 1. The constant “POOL_SIZE,” declared on line 16, is an even integer that specifies the size of the Protection Key value pool. Thus, POOL_SIZE protection keys are allocated for hardware-enforced semaphores. The value of the constant POOL_SIZE may vary according to selection of an appropriate balance point between the two extremes of the total number of protection keys available, in one typical computer system 224, and a single protection key for all semaphores. Generally, the larger the value for the constant POOL_SIZE, the less chance that two semaphores that share a common protection key will mask software errors. However, protection keys are used for reasons other than semaphores, and, conceivably, an application might actually desire more semaphores than the total number of protection keys available. Thus, in general, the POOL_SIZE constant will be assigned a value that balances the need to share a protection key among as few hardware-enforced semaphores as possible, while not allocating the entire protection-key-value space for use by hardware-enforced protection keys. The four forward-class definitions of lines 17-20 allow for subsequent declarations of forward-referencing class declarations.

Next, in the C++-like pseudocode implementation, a number of class declarations are provided. These classes represent certain hardware primitives, kernel primitives, and kernel/operating-system primitives used in the implementation of a hardware-enforced semaphore. The class “semaphore” implements a hardware-enforced semaphore that represents on embodiment of the present invention. First, the class “hardware” is provided:

| | |
|---|---|
| 1 | class hardware |
| 2 | { |
| 3 | public: |
| 4 | processControlBlock* getCurrentPCB(); |
| 5 | void insertProtectionKeyIntoPKR (int pkregister, |
| | Protection_Key pk); |
| 6 | void clearPKR (int pkregister); |
| 7 | byte testAndSet(byte* b); |
| 8 | Protection_Key getProtectionKey(Memory_Address m); |
| 9 | hardware(kernel* k); |
| 10 | virtual ˜hardware(); |
| 11 | }; |

The class “hardware” includes a number of hardware primitives used in the implementation of hardware-enforced semaphores, below. It is by no means an attempt to fully specify or model the hardware architecture of a computer system. Moreover, implementations of the member functions are not provided, as they are well-known in the art and depend many on other, unspecified features of the system architecture. The class “hardware” includes the following member functions representing hardware primitives: (2) “getCurrentPCB,” declared on line 4, that returns a pointer to the process control block of the currently executing process or thread; (2) “insertProtectionKeyIntoPKR,” declared on line 5, which represents a machine instruction or machine-instruction-routine for inserting a specified protection key into a specified protection-key register; (3) “clearPKR,” declared above on line 6, that removes a protection key from a specified protection-key register, for example by inserting into the specified protection-key register a null protection-key value; (4) “testAndSet,” declared above on line 7, that represents a byte-test-and-set instruction provided by the architecture for implementing spin locks and other mechanisms that require an atomic fetch and store operation; (5) “getProtectionKey,” declared above on line 8, that returns the protection key associated with a memory region that includes the virtual address specified as argument “m;” and (6) a constructor and destructor.

The class “kernel,” provided below, represents kernel, operating-system, or kernel/operating-system primitives needed for implementation of hardware-enforced semaphores:

| | |
|---|---|
| 1 | class kernel |
| 2 | { |
| 3 | friend class semaphore; |
| 4 | friend class hardware; |
| 5 | private: |
| 6 | Protection_Key pools[POOL_SIZE]; |
| 7 | int poolsizes[POOL_SIZE]; |
| 8 | int nextPool; |
| 9 | int increment; |
| 10 | Protection_Key allocateProtectionKey(); |
| 11 | void deallocateProtectionKey(Protection_Key pk); |
| 12 | Memory_Address allocateMemory(int numPages, |
| | Protection_Key pk, |
| 13 | Access_Rights* ar); |
| 14 | int deallocateMemory(Memory_Address m); |
| 15 | semaphore* allocateSemaphore(Access_Rights* ar); |
| 16 | void deallocateSemaphore(semaphore* s); |
| 17 | void logEvent(EVENTS e, processControlBlock* pcb); |
| 18 | processControlBlock* getCurrentPCB(); |
| 19 | int randomOddInteger(int min, int max); |
| 20 | void incPool(); |
| 21 | protected: |
| 22 | void addSemaphorePK(semaphore* s); |
| 23 | void deleteSemaphorePK(semaphore* s); |
| 24 | void protectionKeyFaultHandler(Protection_Key pk); |
| 25 | public: |
| 26 | semaphore* createSemaphore(int val, int numPages, |
| 27 | Access_Rights* ar); |
| 28 | void destroySemaphore(semaphore* 5); |
| 29 | kernel(); |
| 30 | ˜kernel(); |
| 31 | }; |

The class “kernel” includes the following data members, declared above on lines 6-9: (1) “pools,” as array of Protection_Key values, each entry in the array representing a pool of hardware-enforced software devices that commonly employ the Protection_Key value; (2) “poolsizes,” an array containing the number of hardware-enforced devices in each pool, or, in other words, an entry with index i in “poolsizes” represents the number of hardware-enforced software devices commonly employing the Protection_Key value stored in the entry in the i-th entry of the array “pools;” (3) “nextPool,” the index of the next Protection_Key to allocate for a newly created, hardware-enforced software device; and (4) “increment,” the number of positions within the array “pools” to skip when seeking a next Protection_Key value to assign.

The class “kernel” includes the following private member functions: (1) “allocateProtectionKey” and “deallocateProtectionKey,” member functions that provide allocation of a unique protection key and deallocation of a specified protection key by one of many different protection-key management algorithms, respectively; (2) “allocateMemory” and “deallocateMemory,” declared above on lines 12-14, that manage memory by one of many different memory-management algorithms, in order to provide the virtual address of a newly allocated memory region, specified by the number of pages of memory for the region to hold, a protection key to be associated with the memory region, and access rights to be associated with the memory region, and to deallocate a memory region specified by a virtual memory address, returning the number of pages deallocated, respectively; (3) “allocateSemaphore” and “deallocateSemaphore,” declared above on lines 15 and 16, that allocate and deallocate instances of the class “semaphore,” where the access rights to be associated with the memory including the semaphore are supplied as arguments for allocation and a pointer to an existing semaphore supplied as an argument for deallocation; (4) “logEvent,” declared above on line 17, that logs a particular event into a log file that can be later accessed by a system developer or programmer, each log event associated with a process control block, a reference to which is supplied as an argument, to indicate to the logging routine the identity of the process or thread context in which the event occurred; (6) “getCurrentPCB,” declared above on line 18, that returns a pointer to the process block associated with the currently executing routine, or, more exactly, the routine that was executing prior to a fault, interrupt, or trap resulting in execution of the kernel or operating system represented by class “kernel;” (7) “randomOddInteger,” declared above on line 19, that returns an odd random integer between, but no including, the range extremes specified as arguments; and (8) “incPool,” that increments data member “nextPool” for selecting a next Protection_Key value to associate with a semaphore.

The class “kernel” includes the following protected member functions: (1) “addSemaphorePK,” declared above on line 22, that inserts the protection key associated with a specified semaphore into the protection-key registers and into a semaphore-related protection-key container associated with a process or thread; (2) “deleteSemaphorePK,” declared above on line 23, that removes the protection key associated with a specified semaphore from the protection-key registers and from a semaphore-related protection-key container associated with a process or thread; and (3) “protectionKeyFaultHandler,” declared above on line 24, that handles protection-key faults at the kernel level.

Finally, the class “kernel” includes the following public member functions: (1) “createSemaphore,” declared above on line 26, that creates an instance of the class semaphore according to a specified semaphore value, a specified number of pages in the memory region that the semaphore is created to protect, and access rights to be associated with both the semaphore and the protected memory region; (2) “destroySemaphore,” declared above on line 28, that deallocates memory associated with the semaphore and then deallocates the semaphore itself; and (3) a constructor and destructor. Note that, in the current implementation, a semaphore is created at the same time that the memory region protected by the semaphore is allocated. In alternate implementations, the semaphore and memory region may be allocated separately. Note that the access rights are common both to the memory in which the semaphore resides as well as the memory region protected by the semaphore, but, again, in alternate embodiments, access rights may be separately specified for the semaphore and the memory region that it protects. Note that, as is the case with the class “hardware,” implementations of many of the member functions of the class “kernel” are not provided, because these functionalities are well-known in the art and because there are many different possible ways of implementing memory and other resource management routines in the other private member functions.

Next, a declaration for the class “waitQueue” is provided:

| | |
|---|---|
| 1 | class waitQueue |
| 2 | { |
| 3 | public: |
| 4 | virtual void queue(); |
| 5 | void signal(); |
| 6 | void signalAll(); |
| 7 | int numWaiters(); |
| 8 | }; |

The class “waitQueue” represents one of any number of possible implementations of a traditional wait queue that allows processes or threads to wait for the occurrence of a specific event or type of event. Wait queues are frequently provided by operating systems to allow processes and threads to be suspended pending various user-defined and system-defined events. Wait queues are well known in the art, and implementations of the member functions for the class “waitQueue” are therefore not provided. The member functions for the class “waitQueue” include: (1) “queue,” declared above on line 4, that is called by a process or thread to suspend itself on a wait queue; (2) “signal,” declared above on line 5, that allows an executing process or thread to signal the wait queue, de-suspending the longest waiting process or thread or incrementing a signal counter so that the next process or thread that attempts to wait on the wait queue will proceed without waiting after decrementing the signal counter variable; (3) “signalAll,” declared on line 6, that provides a sufficient number of signals to the wait queue in one operation to allow all suspended processes and threads to be awakened; and (4) “numWaiters,” declared above on line 7, that returns a number of processes and/or threads currently suspended on the wait queue.

Next, the class “PKs” is declared:

| | |
|---|---|
| 1 | class PKs |
| 2 | { |
| 3 | public: |
| 4 | Protection_Key getPK(int i); |
| 5 | int findPK(Protection_Key pk); |
| 6 | int addPK(Protection_Key pk); |
| 7 | void removePK(Protection_Key pk); |
| 8 | void removePK(int i); |
| 9 | }; |

The class “PKs” implements a protection-key container. An instance of this class is included in a process control block in order to maintain a set of semaphore-related protection keys associated with a process or thread. There are many possible ways of implementing such a container class for protection keys. These implementations are well-known in the art, and therefore implementations of the member functions of the class “PKs” are not provided in this document. The class “PKs” includes the following member functions: (1) “getPK,” declared above on line 4, that returns the i-th protection key in an instance of the class PKs' (2) “findPK,” declared above on line 5, that returns the ordinal for a specified protection key if the protection key is contained in an instance of the class “PKs,” and a value less than zero otherwise; (3) “addPK,” declared above on line 6, that adds a protection key to the container; (4) “removePK,” declared above on line 7, that removes a specified protection key from the container instance of the class “PKs;” and (5) “removePK,” declared above on line 8, that removes the i-th protection key from the container represented by an instance of the class “PKs.”

Next, the class “processControlBlock” is declared:

| | |
|---|---|
| 1 | class processControlBlock |
| 2 | { |
| 3 | private: |
| 4 | int64 processID; |
| 5 | int64 psr; |
| 6 | int64 stkptr; |
| 7 | PKs semaphoreKeys; |
| 8 | public: |
| 9 | int64 getProcessID() {return processID;}; |
| 10 | void setProcessID(int64 id) {processID = id;}; |
| 11 | int64 getPsr() {return psr;}; |
| 12 | void setPsr(int64 p) {psr = p;}; |
| 13 | int64 getStackPtr() {return stkptr;}; |
| 14 | void setStackPtr(int64 stk) {stkptr = stk;}; |
| 15 | PKs* getSemaphorePKs() {return &semaphoreKeys;}; |
| 16 | }; |

The class “processControlBlock” includes the following representative data members: (1) a process ID; (2) the contents of a process or status register; (3) the value of a stack pointer register; and (4) “semaphoreKeys,” declared above on line 7, which contains the protection keys associated with semaphores currently held by the process or thread associated with the PCB represented by an instance of the class “processControlBlock.” In general, the data members reflect values necessary of saving the context of a process or thread, and are hardware-dependent. A PCB generally contains many more data members than the four data members included in the class “processControlBlock.” The class “processControlBlock” includes the following member functions: (1) “getProcessID” and “setProcessID,” declare above on lines 9-10, that get and set the processID data member; (2) “getPsr” and “setPsr, ” declared above on line 11-12, that get and set the psr data member; (3) “getStackPtr” and “setStackPtr,” declared above on lines 13-14, that get and set the stkptr data member; and (5) “getSemaphorePKs,” declared above on line 15, that returns a reference to the container of semaphore-related protection keys associated with the process control block. Note that an instance of the class “PKs” is included within the class “processControlBlock.” In alternative implementations, the container may be referenced from the class “processControlBlock.”

Next, two global variables “k” and “hdwr” are declared to represent the kernel and hardware interface of a particular computer system:

1 kernel k;

2 hardware hdwr(&k);

Finally, the class “semaphore” is declared below:

| | |
|---|---|
| 1 | class semaphore |
| 2 | { |
| 3 | private: |
| 4 | int value; |
| 5 | byte_lock; |
| 6 | waitQueue semWait |
| 7 | Memory_Address mem; |
| 8 | waitQueue* getSemWait() {return &semWait;}; |
| 9 | void setMem(Memory_Address m) {mem = m;}; |
| 10 | void incValue() {value+= 1;}; |
| 11 | void decValue() {value−= 1;}; |
| 12 | void setValue(int v) {value = v;}; |
| 13 | public: |
| 14 | void init(int val, Memory_Address m); |
| 15 | Memory_Address getMem() {return mem;}; |
| 16 | int getValue() {return value;}; |
| 17 | int getSpinLock() {return hdwr.testAndSet(&_lock);}; |
| 18 | void releaseSpinLock() {_lock = 0;}; |
| 19 | int numWaiters() {return semWait.numWaiters();}; |
| 20 | void unlock(); |
| 21 | void lock(); |
| 22 | semaphore(); |
| 23 | ˜semaphore(); |
| 24 | }; |

The class “semaphore” is implemented as one embodiment of the present invention. The implementations for all member functions of the class “semaphore” are provided below. The class semaphore includes the following data members: (1) “value,” declared above on line 4, that contains a value representing the current availability of the semaphore, or, in other words, the number of processes or threads that can obtain access to the memory protected by the semaphore immediately, without waiting; (2) “_lock,” the byte quantity that serves as the spin lock for access to semaphore routines; (3) “semWait,” declared above on line 5, a wait queue on which processes and threads waiting to obtain access to the memory protected by the semaphore are suspended; and (4) “mem,” declared above on line 6, the address of the beginning virtual memory region protected by the semaphores.

The class “semaphore” includes the following private member functions: (1) “getSemWait,” declared above on line 8, that returns a reference to the wait queue contained within the semaphore; (2) “setMem,” declared above on line 9, that stores a specified virtual-memory address into the data member “mem” to represent the starting address of the memory region protected by the semaphore; (3) “incValue,” declared above on line 10, that increments the value stored in data member “value;” (4) “decValue,” declared above on line 11, that decrements the value stored in the data member “value;” and (5) “setValue,” declared above on line 12, that stores a specified value into the data member “value.” The class “semaphore” includes the following public function members: (1) “init,” declared above on line 14, that initializes the value and Memory_Address data members of the semaphore; (2) “getMem,” declared above on line 15, that returns the address stored within the data member “mem;” (3) “getValue,” declared above on line 16, that returns the value stored in data member “value;” (4) “getSpinLock,” declared above on line 16, that uses a byte-test-and-set-hardware instruction to return the value stored in data member “_lock” while, at the same time, setting the value of data member “_lock” to 1; (5) “releaseSpinLock,” declared above on line 17, that sets the value stored in data member “_lock” to 0, thereby releasing the spin lock for acquisition by another process or thread; (6) “numWaiters,” declared above on line 18, that returns the number of processes and threads currently queued to the wait queue “semWait;” (7) “unlock,” declared above on line 19, a basic semaphore routine that releases a previous grant for memory access; (8) “lock,” declared above on line 20, a basic semaphore routine that is called by a process or thread to acquire a grant for memory access from an instance of the class “semaphore,” resulting in either an immediate grant for access or suspension of the process or thread on a wait queue until the semaphore can grant access to memory to the waiting process or thread; and (9) a constructor and destructor.

The hardware-enforced semaphore implemented in the C++-pseudocode implementation is similar to traditional semaphores, with the exception that an instance of the class “semaphore” is hardware enforced via the protection-key mechanism provided by certain modern computer architectures and is directly associated with the address of the memory region protected by the semaphore. There are many possible alternative implementations for a hardware-enforced semaphore, including implementations with additional routines for manipulating data stored in the semaphore, implementations of semaphores that do not store the address of the memory region protected by the semaphore, and many other variants. The described embodiment illustrates use of the protection-key mechanism in combination with traditional semaphore methodology in order to produce one type of hardware-enforced semaphore. This same technique may be incorporated in the many different possible variants of semaphores, as well as in other types of serializing and sequencing software devices related to semaphores.

Two kernel public function members are implemented below. An implementation for the kernel function member “createSemaphore” is provided first:

| | |
|---|---|
| 1 | semaphore* kernel::createSemaphore(int val, int numPages, |
| | Access_Rights* ar) |
| 2 | { |
| 3 | semaphore* s; |
| 4 | Protection_Key pk; |
| 5 | Memory_Address m; |
| 6 | incPool(); |
| 7 | pk = pools[nextPool]; |
| 8 | poolsizes[nextPool]+= numPages; |
| 9 | m = allocateMemory(numPages, pk, ar); |
| 10 | if(m == 0) |
| 11 | { |
| 12 | // error condition |
| 13 | } |
| 14 | s = allocateSemaphore(ar); |
| 15 | if (s == 0) |
| 16 | { |
| 17 | deallocateMemory(m); |
| 18 | // error condition |
| 19 | } |
| 20 | s->init(val, m); |
| 21 | #ifdef_SEM_LOG_EVENTS |
| 22 | log Event(SemaphoreCreation, hdwr.getCurrentPCB()); |
| 23 | #endif |
| 24 | return s; |
| 25 | } |

The kernel routine “createSemaphore” receives the following arguments: (1) “val,” the value for initializing the semaphore data member “value,” which controls the number of processes or threads that may concurrently access a memory region protected by the semaphore; (2) “numPages,” the number of memory pages to be allocated for the memory region protected by the semaphore; and (3) “ar,” the access rights to be associated with both the memory in which the semaphore is located as well as the memory region protected by the semaphore. The kernel routine “createSemaphore” employs three local variables: (1) “s,” a pointer to the newly created semaphore; (2) “pk,” a protection key allocated for association with the semaphore; and (3) “m,” the address of a memory region allocated for protection by the semaphore. These local variables are declared above, on lines 3-5. The routine “createSemaphore” first selects a protection key, on lines 6-8, to associate with the new semaphore. On line 6, createSemaphore increments the data member “nextPool” to the index of the next entry in “pools” from which to select a Protection_Key value. On line 7, local variable “pk” is set to the selected Protection_Key value, and, on line 8, the size of the pool corresponding to the selected Protection_Key value is incremented by the number of pages included in the memory region allocated for the semaphore to protect. Next, on line 9, createSemaphore allocates the memory region to be protected by the semaphore. If no memory region is obtained, as detected on line 10, then an error condition has occurred which is handled by some error handling code that is not specified in the current implementation. Error handling can be achieved in many different ways, and may be highly dependent on various aspects of underlying machine architectures and kernel and operating system implementations. Error handling is not. therefore, implemented in this or any other routine of the C++-pseudocode implementation. On line 14, createSemaphore allocates the semaphore itself, and on line 20, initializes the semaphore. Semaphore creation events may be logged on line 22 to enable programmers and system developers to later reconstruct the sequence of semaphore-related events that occurred during system operation. Finally, on line 24, createSemaphore returns a reference to the newly created semaphore. As noted above, the kernel routines of the current implementation may, in alternate implementations, be distributed between kernel and operating-system layers.

An implementation of the kernel routine “destroySemaphore” is provided below:

| | |
|---|---|
| 1 | void kernel::destroySemaphore(semaphore* s) |
| 2 | { |
| 3 | Protection Key pk; |
| 4 | int i, numPages; |
| 5 | if (s == 0) |
| 6 | { |
| 7 | // error condition |
| 8 | } |
| 9 | if (s->getSpinLock() == 1) |
| 10 | { |
| 11 | // error condition - someone accessing |
| 12 | } |
| 13 | if (s->numWaiters() > 0) |
| 14 | { |
| 15 | // error condition |
| 16 | } |
| 17 | pk = hdwr.getProtectionKey(s->getMem()); |
| 18 | numPages = deallocateMemory(s->getMem()); |
| 19 | deallocateSemaphore(s); |
| 20 | for (i = 0; i < POOL_SIZE; i++) |
| 21 | { |
| 22 | if (pools[i]== pk) |
| 23 | { |
| 24 | poolsizes[i]−= numPages; |
| 25 | break; |
| 26 | } |
| 27 | } |
| 28 | #ifdef_SEM_LOG_EVENTS |
| 29 | logEvent(SemaphoreDestruction, hdwr.getCurrentPCB()); |
| 30 | #endif |
| 31 | } |

The routine “destroySemaphore” receives, as an argument, a reference to the semaphore to be destroyed. The routine “destroySemaphore” employs a three local variables “pk,” “i,” and “numPages,” declared on lines 3-4, to store the value of a protection key, the index of the protection key in the array “pools,” and the number of pages in the memory region protected by the semaphore, respectively. On line 9, destroySemaphore attempts to gain access to semaphore routines via the semaphore function member “getSpinLock.” If access to the semaphore is not obtained, then an error condition has occurred. Access has been denied because another process or thread is currently accessing the semaphore routines. However, the routine “destroySemaphore” should be called only after processes and threads no longer attempt to access the semaphore. Similarly, on line 13, destroySemaphore determines whether there are any processes or threads waiting in the wait queue associated with the semaphore. Again, if there are waiting processes or threads, then an error condition has occurred. In both cases, the error condition can be handled in many different ways. Generally, the semaphore can be destroyed after awakening any waiting processes, and subsequent errors caught through protection key faults. On lines 17, destroySemaphore determines the protection key associated with the entry region protected by the semaphore. Then, on lines 18-20, destroySemaphore deallocates the memory region, deallocates the semaphore itself, and decrements the entry in the array “poolsizes” by the number of pages of memory deallocated. Semaphore destruction events may be logged, on line 29.

Implementations of the kernel routines “addSemaphorePK” and “deleteSemaphorePK” are provided below:

| | |
|---|---|
| 1 | void kernel::addSemaphorePK(semaphore* s) |
| 2 | { |
| 3 | Protection_Key pk = hdwr.getProtectionKey(s->getMem()); |
| 4 | processControlBlock* pcb = hdwr.getCurrentPCB(); |
| 5 | PKs* pks = pcb->getSemaphorePKs(); |
| 6 | pks->addPK(pk); |
| 7 | hdwr.insertProtectionKeyIntoPKR(SEMKEY, pk); |
| 8 | } |
| 9 | void deleteSemaphorePK(semaphore* s) |
| 10 | { |
| 11 | |
| 12 | Protection_Key pk = hdwr.getProtectionKey(s->getMem()); |
| 13 | processControlBlock* pcb = hdwr.getCurrentPCB(); |
| 14 | PKs* pks = pcb->getSemaphorePKs(); |
| 15 | pks->removePK(pk); |
| 16 | hdwr.clearPKR(SEMKEY); |
| 17 | } |

The kernel routine “addSemaphorePK” inserts the protection key associated with a semaphore, a reference to which is supplied as argument “s,” into the protection-key registers as well as into the process control block of a process or thread. The kernel routine “deleteSemaphorePK” removes the protection key associated with a semaphore from the protection-key registers and from the process control block of the currently executing process or thread. These two routines thus provide the hardware and kernel-level support for making the protection key associated with the semaphore available to a process or thread during execution of the semaphore routine “block,” and remove the protection key associated with the semaphore from use by a process or thread.

An implementation of the kernel routine “protectionKeyFaultHandler” is provided below:

| | |
|---|---|
| 1 | void kernel::protectionKeyFaultHandler(Protection_Key pk) |
| 2 | { |
| 3 | bool handled; |
| 4 | processControlBlock* pcb = hdwr.getCurrentPCB(); |
| 5 | PKs* pks; |
| 6 | // do all normal protection key fault handling |
| 7 | |
| 8 | if(!handled) |
| 9 | { |
| 10 | pks = pcb->getSemaphorePKs(); |
| 11 | if (pks->findPK(pk)) |
| 12 | { |
| 13 | hdwr.insertProtectionKeyIntoPKR(SEMKEY, pk); |
| 14 | handled = true; |
| 15 | } |
| 16 | } |
| 17 | if(!handled) |
| 18 | { |
| 19 | #ifdef_SEM_LOG_EVENTS |
| 20 | logEvent(PKFauIt, hdwr.getCurrentPCB()); |
| 21 | #endif |
| 22 | // recover from fault |
| 23 | } |
| 24 | } |

The routine “protectionKeyFaultHandler” is invoked by the hardware protection-key mechanism upon protection-key faults. The above-provided implementation shows only those portions of the routine “protectionKeyFaultHandler” related to hardware-enforced semaphores. The routine “protectionKeyFaultHandler” receives a protection key as input. The routine “protectionKeyFaultHandler” employs three local variables, declared above on lines 3-5: (1) “handled,” a Boolean variable indicating whether or not the protection key fault has been handled satisfactorily by code within the routine; (2) “pcb,” a reference to a process control block; and (3) “pks,” a reference to a protection key container within a process control block. As indicated by the comment on line 6, the routine “protectionKeyFaultHandler” processes the protection key fault in normal ways prior to the hardware-enforced-semaphore-related code that follows. A given process or thread may be associate with many different protection keys, only a few of which may reside in the protection-key registers at any particular point in time. Thus, protection key faults are frequent occurrences, resulting in migration of protection keys from memory to the cache-like protection-key registers. On line 7, if the protection-key fault has not been handled, “protectionKeyFaultHandler” obtains a reference to the semaphore-related protection-key container within the PCB of the currently executing process or thread and calls the PKs routine “findPK” to determine whether the protection key that caused the protection key fault is contained within the semaphore-related protection-key container. If so, as detected on line 10, the protection key is inserted into one of the protection-key registers via a hardware instruction, on line 12, and the local variable “handled” is set to TRUE. If the protection key fault is not handled, as detected on line 16, then the protection key fault event may be logged, on line 20.

Next, kernel routines for incrementing the nextPool kernel data member, “incPool,” and a constructor are provided:

| | |
|---|---|
| 1 | void kernel::incPool() |
| 2 | { |
| 3 | int next, nexter; |
| 4 | next = nextPool + increment; |
| 5 | if (next >= POOL_SIZE) next -= POOL_SIZE; |
| 6 | if (poolsizes[next] >= poolsizes[nextPool]) |
| 7 | { |
| 8 | nexter = next + increment; |
| 9 | if (nexter >= POOL_SIZE) nexter -= POOL_SIZE; |
| 10 | if (poolsizes[nexter] >= poolsizes[next]) nextPool = next; |
| 11 | else nextPool = nexter |
| 12 | } |
| 13 | } |
| 14 | kernel::kernel() |
| 15 | { |
| 16 | int i; |
| 17 | increment = randomOddInteger(0, POOL_SIZE); |
| 18 | for (i = 0; i < POOL_SIZE; i++) |
| 19 | { |
| 20 | pools[i] = allocateProtectionKey(); |
| 21 | poolsizes[i] = 0; |
| 22 | } |
| 23 | nextPool = −1; |
| 24 | } |

The routine “incPool” employs two local variables, “next” and “nexter,” declared above on line 3 of incPool. These local variables hold candidate indexes for selecting the next pool from which to distribute the corresponding protection key. The first candidate index is found by incrementing nextPool by the value stored in data member “increment” and storing the result in local variable “next.” However, if the number of memory pages protected with the protection key stored in the array “pools” at index “nextPool” is lower than the number of memory pages protected with the protection key stored in the array “pools” at index “next,” as detected on line 6, then nextPool is not incremented by incPool, so that the same protection-key value is used twice in a row. Otherwise, on lines 8-11, incPool looks ahead to the index to be used after that stored in “next,” placing that next index in local variable “nexter,” choosing between key values in array “pools” at the indices stored in next and nexter based on the number of memory pages currently protected by each protection key. This rather complex increment of data member “nextPool” helps to evenly distribute protection keys allocated for semaphores over memory regions protected by semaphores. The routine “incPool” uses a random generated increment, on line 17, so that problems masked by reuse of protection-key values during a first system operation may be unmasked by a different protection-key distribution among semaphores in a second or subsequent system operation. For example, if two semaphores are both associated with the same protection key, and a program mistakenly accesses memory associated with the second semaphore without calling the second semaphore's lock routine, after having called the first semaphore's lock routine, then the programming error will not be detected through a protection-key fault, since the executing process will have obtained the protection key protecting both memory regions by calling the first semaphore's lock routine. By distributing protection keys among semaphores different each time, such programming errors will, with sufficient trials, almost certainly be uncovered.

Finally, implementations for the semaphore routines “init,” “unlock,” “lock,” and the constructor are provided. First, an implementation for the semaphore routine “init” is provided below:

| | |
|---|---|
| 1 | void semaphore::init(int val, Memory_Address m) |
| 2 | { |
| 3 | if (getMem() != 0) |
| 4 | { |
| 5 | // error condition |
| 6 | } |
| 7 | setMem(m); |
| 8 | setValue(val); |
| 9 | releaseSpinLock(); |
| 10 | } |

The semaphore routine “init” initializes the data members “Mem,” “Value,” and “_Lock.” The data member “_lock,” the spin lock for the semaphore, is initialized to zero via a call to the routine “relaseSpinLock.” Note that the value inserted into data member “value” is the number of processes or threads that can concurrently access the memory region protected by the semaphore. The semaphore becomes an exclusive lock, for example, if the initial value inserted into data member “value” is 1.

An implementation for the semaphore routine “unlock” is provided below:

| | |
|---|---|
| 1 | void semaphore::unlock() |
| 2 | { |
| 3 | while (true) |
| 4 | { |
| 5 | if (!getSpinLock()) break; |
| 6 | } |
| 7 | k.deleteSemaphorePK(this); |
| 8 | incValue(); |
| 9 | semWait.signal(); |
| 10 | releaseSpinLock(); |
| 11 | } |

The semaphore routine “unlock” is called by a process or thread to release the ability to access the memory region protected by the semaphore, so that other processes or threads waiting for access may then do so. On lines 3-6, the routine “unlock” spins in a spin loop until it is able to acquire the spin lock via a call to the routine “getSpinLock.” This simple mechanism is effective and efficient, in the case that there is generally low contention for semaphores within the system, but can unnecessarily deplete processor bandwidth in systems where there is high contention for semaphores. Thus, in alternate embodiments, after spinning for several iterations, a process may elect to suspend itself for some period of time prior to again trying to acquire the spin lock. Once the spin lock is acquired, the routine “unlock” removes the protection key associated with the semaphore from the PCB and protection-key registers, on line 7, then increments the values stored in data member “value,” on line 8, signals the next waiting process or thread via a call to the wait queue routine “signal” on line 9, and releases the spin lock on line 10.

An implementation for the semaphore routine “lock” is provided below:

| | |
|---|---|
| 1 | void semaphore::lock() |
| 2 | { |
| 3 | while (true) |
| 4 | { |
| 5 | while (true) |
| 6 | { |
| 7 | if (!getSpinLock()) break; |
| 8 | } |
| 9 | if (getValue() > 0) |
| 10 | { |
| 11 | k.addSemaphorePK(this); |
| 12 | decValue(); |
| 13 | releaseSpinLock(); |
| 14 | break; |
| 15 | } |
| 16 | else |
| 17 | { |
| 18 | releaseSpinLock(); |
| 19 | semWait.queue(); |
| 20 | } |
| 21 | } |
| 22 | } |

The semaphore routine “lock” is called by a process or thread in order to acquire a grant to access to the memory region protected by the semaphore. If access can be granted by the semaphore immediately, the process or thread resumes execution. However, if access cannot be granted, the process is suspended on the wait queue associated with the semaphore. The outer while-loop of lines 3-21 represent an outer spin loop which is interrupted when the calling process finally obtains a grant for accessing the memory region protected by the semaphore, on line 13. During each iteration of the outer while-loop, the routine “lock” first tries to acquire the spin lock via the inner while-loop of lines 5-8. Once the spin lock is acquired, the routine “lock” determines whether the value in the semaphore data member “value” is greater than 0, on line 9, indicating that immediate access may be granted to the calling process or thread. If immediate access can be granted, then, on lines 11-13, the routine “lock” adds the protection key associated with the semaphore to the PCB of the process or thread and inserts the protection key into the protection-key registers, decrements the value of the data member “value,” releases the spin lock on line 12, and then breaks out of the outer while-loop on line 13. If immediate access to the memory region cannot be granted, then, on line 18, the routine “lock” releases the spin lock and, on line 19, the process is suspended on the wait queue. Note that this simple algorithm may result in starvation of a calling process or thread under conditions of high contention for the semaphore. For high-contention semaphores, a more elaborate implementation may be used to ensure that an awakened process or thread obtains a grant to access memory.

Finally, a constructor for class “semaphore” is provided:

1 semaphore::semaphore( )

2 {

3 setMem(0);

4 }

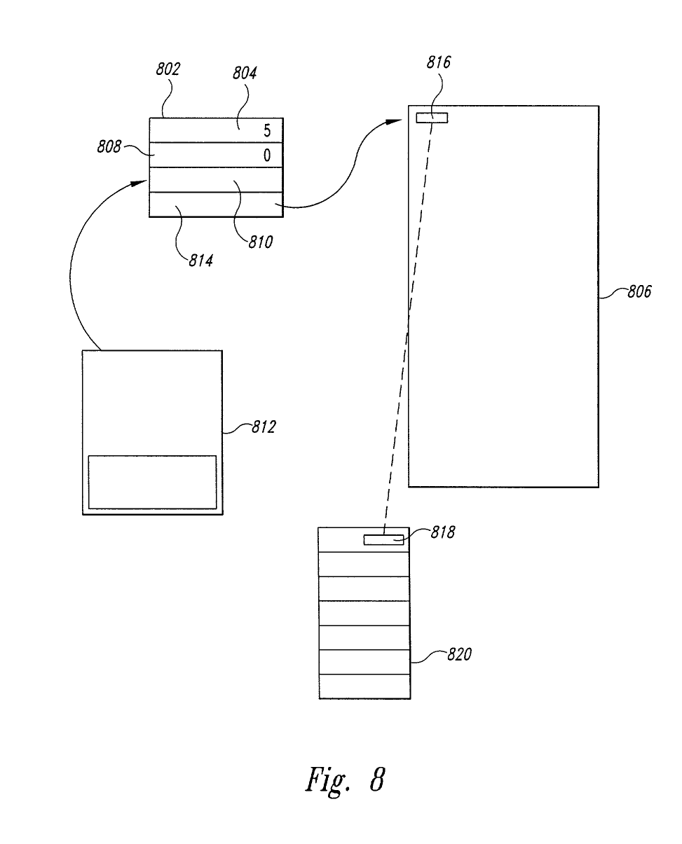

FIG. 8 summarizes, in graphical fashion, the features of the hardware-enforced semaphore described above that represents one embodiment of the present invention. A hardware-enforced semaphore 802 includes a field “value” 804 that contains an integer representing the number of processors or threads that may still obtain immediate grants to a region of memory 806 protected by the semaphore, a spin lock field 808, a wait queue field 810 on which PCBs of waiting processes, such as PCB 812 are queued, and a pointer 814 to the protected memory 806. The semaphore is associated with a protection key 816-818 stored in the PCB of processes granted access via the semaphore to the memory region 806, inserted into one of the protection-key registers 820 for a process granted access to the memory region 806, and associated with the memory region 806.

Although the present invention has been described in terms of a particular embodiment, it is not intended that the invention be limited to this embodiment. Modifications within the spirit of the invention will be apparent to those skilled in the art. For example, as pointed out above, many different semaphore variants and other software mechanisms for controlling access to memory can be designed to incorporate the protection-key hardware enforcement of the present invention. Such software mechanisms need to install a protection key for processes and threads that obtain access to memory and need to remove the protection key, both from protection-key registers and from internal data structures associated with the process or thread, when the process or thread relinquishes access to the protected memory. The above C++-like pseudocode implementation provides one of an almost limitless number of approaches to employing a hardware protection-key mechanism in order to enforce semaphore access grants. Different modular organizations may be employed, different locking features and processing thread suspension mechanisms may be employed, a hardware enforced semaphore may include many different functionalities in addition to those implemented above. In computer systems with different architectures, a memory-protection mechanism other than protection keys may be employed to enforce access grants via semaphores. Note that, in the above discussion, hardware-enforced semaphores are described as being provided to processes and threads, but that these terms are intended to generally stand for any executing entity within a computing environment, including execution threads and other types of executing entities, associated with an operating-system context. In the above C++-like pseudocode implementation, protection keys are inserted and removed from the protection-key registers during semaphore-based memory-access grants and revocations, but, as an alternative, the protection-key registers containing the protection keys may be validated and invalidated, rather than inserted and removed, or may be either invalidated or removed and either validated or inserted.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the following claims and their equivalents:

1. A method for protecting access to a memory region associated with a protection key within a computer system, the method comprising:
providing a hardware-enforced semaphore to executing entities that may access the memory region;
when an executing entity obtains access to the memory region by calling an access-granting routine associated with the semaphore, inserting the protection key into a protection-key register; and
when an executing entity relinquishes access to the memory region by calling an access-grant-removing routine associated with the semaphore, removing the protection key from the protection-key register.

2. The method of claim 1 further including:
when an executing entity obtains access to the memory region by calling an access-granting routine associated with the semaphore, inserting the protection key into a protection-key register and into an internal data structure associated with the executing entity; and
when an executing entity relinquishes access to the memory region by calling an access-grant-removing routine associated with the semaphore, removing the protection key from the protection-key register and from the internal data structure associated with the executing entity.

3. The method of claim 1 further comprising:
when allocating memory for protection by the semaphore, selecting a protection key from a pool of protection keys reserved for semaphores to associate with the memory region and with the semaphore.

4. Computer instructions for carrying out the method of claim 1 for protecting access to a memory region associated with a protection key encoded by a technique selected from among:
encoding the instructions in a computer-readable storage medium;
encoding the instructions as electronic signals for transmission via an electronic communications medium; and
printing the results in a human-readable format.

5. A method for hardware-enforcing access granted to a memory region by a serialization-and-sequencing software device, the method comprising:
during granting of access by the serialization-and-sequencing software device, inserting a protection key associated with the memory region into a protection-key register; and
during revocation of a grant of access by the serialization-and-sequencing software device, removing a protection key associated with the memory region into from protection-key register.

6. The method of claim 5 further comprising:
during granting of access by the serialization-and-sequencing software device, inserting a protection key associated with the memory region into a protection-key register and into an internal data structure associated with the executing entity to which access is being granted; and
during revocation of a grant of access by the serialization-and-sequencing software device, removing a protection key associated with the memory region into from protection-key register and from the internal data structure associated with the executing entity from which access is being revoked.

7. The method of claim 5 further comprising:
when allocating memory for protection by the serialization-and-sequencing software device, selecting a protection key from a pool of protection keys reserved for the serialization-and-sequencing software devices to associate with the memory region and with the serialization-and-sequencing software device.

8. Computer instructions for carrying out the method of claim 5 for hardware-enforcing access granted to a memory region by a serialization-and-sequencing software device encoded by a technique selected from among:
encoding the instructions in a computer-readable storage medium;
encoding the instructions as electronic signals for transmission via an electronic communications medium; and
printing the results in a human-readable format.

9. A hardware-enforced serialization-and-sequencing software device for protecting a region of memory, the serialization-and-sequencing software device comprising:
an access lock for serializing access to the serialization-and-sequencing software device;
an associated access granting routine that enables hardware-level access to the region of memory by a requesting executing entity; and
an associated access relinquishing routine that disables hardware-level access to the region of memory by a requesting executing entity.

10. The hardware-enforced serialization-and-sequencing software device of claim 9 wherein the serialization-and-sequencing software device is a semaphore.

11. The hardware-enforced serialization-and-sequencing software device of claim 9 wherein enabling hardware-level access comprises insertion of a protection key associated with the memory region into a protection key register.

12. The hardware-enforced serialization-and-sequencing software device of claim 9 wherein disabling hardware-level access comprises removal of a protection key associated with the memory region from a protection key register.

13. The hardware-enforced serialization-and-sequencing software device of claim 9 wherein enabling hardware-level access comprises insertion of a protection key associated with the memory region into a protection key register and insertion of the protection key into an internal data structure associated with the requesting executing entity.

14. The hardware-enforced serialization-and-sequencing software device of claim 9 wherein disabling hardware-level access comprises removal of a protection key associated with the memory region from a protection key register and removal of the protection key from the internal data structure associated with the requesting executing entity.

15. The hardware-enforced serialization-and-sequencing software device of claim 9 wherein the access lock is a spin lock.

16. The hardware-enforced serialization-and-sequencing software device of claim 9 further including a count indicating the number of executing entities that may gain immediate access to the memory.

17. The hardware-enforced serialization-and-sequencing software device of claim 16 wherein the count is decremented with each access grant and incremented with each access relinquishment.

18. The hardware-enforced serialization-and-sequencing software device of claim 9 further including an address of the memory region.

19. The hardware-enforced serial ization-and-sequencing software device of claim 9 further including a wait queue for processes and threads waiting for access to the memory region.

20. The hardware-enforced serialization-and-sequencing software device of claim 19 wherein, when an executing entity relinquishes access by calling the access relinquishing routine, an executing entity suspended on the wait queue is awakened.

21. The hardware-enforced serialization-and-sequencing software device of claim 9 wherein enabling hardware-level access comprises insertion of a protection key associated with the memory region and selected from a among a pool of protection keys reserved for memory regions protected by serialization-and-sequencing software devices into a protection key register.

22. A hardware-enforced serialization-and-sequencing software device for protecting a region of memory, the serialization-and-sequencing software device comprising:
a means for serializing access to the serialization-and-sequencing software device;
a means for enabling access to the region of memory for an executing entity requesting access to the region of memory; and
a means for disabling access to the region of memory for an executing entity requesting relinquishment of access to the region of memory.

23. The hardware-enforced serialization-and-sequencing software device of claim 22 wherein the means for serializing access to the serialization-and-sequencing software device is a spin lock.

24. The hardware-enforced serialization-and-sequencing software device of claim 22 wherein the means for enabling access to the region of memory for an executing entity requesting access to the region of memory comprises inserting a protection key associated with the region of memory and the hardware-enforced serialization-and-sequencing software device into a protection-key register.

25. The hardware-enforced serialization-and-sequencing software device of claim 22 wherein the means for enabling access to the region of memory for an executing entity requesting access to the region of memory comprises inserting a protection key associated with the region of memory and the hardware-enforced serialization-and-sequencing software device into a protection-key register.

26. The hardware-enforced serialization-and-sequencing software device of claim 22 wherein the means for disabling access to the region of memory for an executing entity requesting relinquishment of access to the region of memory comprises removing a protection key associated with the region of memory and the hardware-enforced serialization-and-sequencing software device from a protection-key register.

27. A method for protecting access to a memory region associated with a protection key within a computer system, the method comprising:
providing a hardware-enforced semaphore to executing entities that may access the memory region;
when an executing entity obtains access to the memory region by calling an access-granting routine associated with the semaphore,
when the protection key already resides in a protection-key register, validating the protection-key register, and
when the protection key does not already reside in a protection-key register, inserting the protection key into a protection-key register; and
when an executing entity relinquishes access to the memory region by calling an access-grant-removing routine associated with the semaphore, invalidating the protection-key register that contains the protection key.
